(19) United States
(12) Patent Application Publication
(10) Pub. No.: US 2013/0151333 A1
(43) Pub. Date: Jun. 13, 2013

(54) AFFECT BASED EVALUATION OF ADVERTISEMENT EFFECTIVENESS

(71) Applicant: AFFECTIVA, INC., Waltham, MA (US)

(72) Inventors: Rana el Kaliouby, Waltham, MA (US); Avril England, Pleasanton, CA (US); Rosalind Wright Picard, Newtonville, MA (US); Brent Sapiro, San Jose, CA (US); Zhihong Zheng, Lexington, MA (US)

(73) Assignee: AFFECTIVA, INC., Waltham, MA (US)

(21) Appl. No.: 13/708,214

(22) Filed: Dec. 7, 2012

Related U.S. Application Data
(60) Provisional application No. 61/568,130, filed on Dec. 7, 2011.
(60) Provisional application No. 61/581,913, filed on Dec. 30, 2011.

(51) Int. Cl. G06Q 30/02

(52) U.S. Cl. CPC G06Q 30/0242
USPC 705/14.45; 705/14.41

(57) ABSTRACT

Analysis of mental states is provided in order to enable data analysis pertaining to affect-based evaluation of advertisement effectiveness. Advertisements can have various objectives, including entertainment, education, awareness, persuasion, startling, or a drive to action. Data, including facial information, is captured for an individual viewer or group of viewers. Physiological information may also be gathered for the viewer or group of viewers. In some embodiments, demographics information is collected and used as a criterion for rendering the mental states of the viewers in a graphical format. In some embodiments data captured from an individual viewer or group of viewers is used to optimize an advertisement.

### RELATED APPLICATIONS

This application claims the benefit of U.S. provisional patent applications “Mental State Evaluation Learning for Advertising” Ser. No. 61/568,130, filed Dec. 7, 2011 and “Affect Based Evaluation of Advertisement Effectiveness” Ser. No. 61/581,913, filed Dec. 30, 2011. The foregoing applications are hereby incorporated by reference in their entirety.

### FIELD OF ART

This application relates generally to analysis of mental states and more particularly to affect-based evaluation of advertisement effectiveness.

### BACKGROUND

The evaluation of mental states is key to understanding people and the way in which they react to the world around them. People's mental states may run a broad gamut: from happiness to sadness, from contentedness to worry, and from excited to calm, among others. These mental states are often experienced in response to everyday events such as frustration during a traffic jam, boredom while standing in line, and impatience while waiting for a cup of coffee. Individuals' perception and empathy towards those around them may increase based on their evaluation and understanding of these surrounding people's mental states. While an empathetic person may, with relative ease, perceive anxiety or joy in another person and respond accordingly, automated evaluation of mental states is a far more challenging undertaking The ability to perceive another person's emotional state, along with the means by which a person achieves this perception, may be quite difficult to summarize or relate and has often been referred to as coming from a “gut feel.”

Confusion, concentration, and worry may be identified by various means in order to aid in the understanding of the mental states of an individual or group of people. For example, people can collectively respond with fear or anxiety, such as may be the case after witnessing a catastrophe. Likewise, people can collectively respond with happy enthusiasm, such as when their sports team wins a major victory. Certain facial expressions and head gestures may be used to identify a mental state that a person or a group of people is experiencing. Limited automation has been performed in the evaluation of mental states based on facial expressions. Certain physiological conditions may further provide telling indications of a person's state of mind. These physiological conditions have been utilized to date, but only in a crude fashion—such as in the apparatus commonly used for polygraph tests.

### SUMMARY

Analysis of mental states may be performed while a viewer or viewers observe an advertisement or advertisements. Analysis of the viewers' mental states may indicate whether the viewers are or will be favorably disposed towards an advertisement and the product or service described therein. A computer implemented method for advertisement evaluation is disclosed comprising: collecting mental state data from a plurality of people as they observe an advertisement wherein the mental state data includes facial data; analyzing the mental state data to produce mental state information; and predicting an advertisement effectiveness based on the mental state information.

The method may further comprise comparing the advertisement effectiveness that was predicted with actual sales. The advertisement effectiveness may indicate a prediction of short term sales changes. The advertisement effectiveness may be based on multiple exposures to the advertisement. The advertisement effectiveness may be based on an advertisement objective which includes one or more of entertainment, education, awareness, persuasion, startling, or a drive to action. The predicting of the advertisement effectiveness may use one or more effectiveness descriptors and an effectiveness classifier. The predicting of the advertisement effectiveness may be based on evaluation of a dynamics baseline. One of the one or more effectiveness descriptors may have a larger standard deviation and the larger standard deviation corresponds to higher advertisement effectiveness. The method may further comprise developing norms based on a plurality of advertisements and wherein the norms are used in the predicting. The method may further comprise combining a plurality of effectiveness descriptors to develop an expressiveness score wherein a higher expressiveness score corresponds to a higher advertisement effectiveness. The expressiveness score may be related to total movement for faces of the plurality of people. Probabilities for one of the one or more effectiveness descriptors may vary for portions of the advertisement. The probabilities may be identified at a segment in the advertisement when a brand is revealed. The method may further comprise generating a histogram of the probabilities. The portions may include quarters of the advertisement and the quarters include at least a third quarter and a fourth quarter. A third quarter probability for the advertisement may be higher than a fourth quarter probability for the advertisement and wherein the third quarter having a higher probability corresponds to higher advertisement effectiveness. A fourth quarter probability for the advertisement may be higher than a third quarter probability for the advertisement and wherein the fourth quarter having a higher probability corresponds to higher advertisement effectiveness.

The one of the one or more effectiveness descriptors may include AU12 or valence. The probabilities may increase with multiple views of the advertisement. The probabilities which increase may move to earlier points in time for the advertisement. The method may further comprise establishing a baseline for the one or more effectiveness descriptors. The method may further comprise building an effectiveness probability wherein a higher effectiveness probability correlates to a higher likelihood that the advertisement is effective. The method may further comprise correlating the mental state data from the plurality of people. The method may further comprise collecting mental state data from the plurality of people as they observe multiple advertisements. The method may further comprise clustering the multiple advertisements based on predicted effectiveness. The method may further comprise predicting virality for the advertisement. The method may further comprise aggregating the mental state information into an aggregated mental state analysis which is used in the predicting. The method may further comprise optimizing the advertisement based on the advertisement effectiveness which was predicting. The mental state data may also include one or more of physiological data and actigraphy data. A webcam may be used to capture one or more of the facial data and the physiological data. The method may further comprise inferring mental states about the advertisement based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity. Confusion may correspond to a lower level of advertisement effectiveness. The method may further comprise presenting a subset of the mental state information in a visualization. The visualization may be presented on an electronic display. The visualization may further comprise a rendering based on the advertisement.

In embodiments, a computer program product embodied in a non-transitory computer readable medium for advertisement evaluation may comprise: code for collecting mental state data from a plurality of people as they observe an advertisement wherein the mental state data includes facial data; code for analyzing the mental state data to produce mental state information; and code for predicting an advertisement effectiveness based on the mental state information. In some embodiments, a computer system for advertisement evaluation may comprise: a memory which stores instructions; one or more processors coupled to the memory wherein the one or more processors, when executing the instructions which are stored, are configured to: collect mental state data from a plurality of people as they observe an advertisement wherein the mental state data includes facial data; analyze the mental state data to produce mental state information; and predict an advertisement effectiveness based on the mental state information.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for affect-based evaluation of advertisement effectiveness.

FIG. 2 is a system diagram for capturing mental state data.

FIG. 3 is a graphical representation of mental state analysis.

FIG. 4 is an example dashboard diagram for mental state analysis.

FIG. 5 is a diagram showing a graph and histogram for an advertisement.

FIG. 6 is an example rendering including norms.

FIG. 7 is a system diagram for evaluating mental states.

### DETAILED DESCRIPTION

The present disclosure provides a description of various methods and systems for affect-based evaluation of advertisement effectiveness based on an analysis of people's mental states. Viewers may observe advertisements and have data collected on their mental states. Mental state data from one viewer or a plurality of viewers may be processed to form aggregated mental state analysis, which in turn may be used in the projecting of the effectiveness of advertisements. An advertisement may be optimized based on its projected effectiveness. Computer analysis may be performed of facial and/or physiological data to determine viewers' mental states as they observe various types of advertisements. A mental state may be a cognitive state, an emotional state, or a combination thereof. Examples of emotional states include happiness or sadness, while examples of cognitive states include concentration or confusion. Observing, capturing, and analyzing these mental states can yield significant information about viewers' reactions to various stimuli.

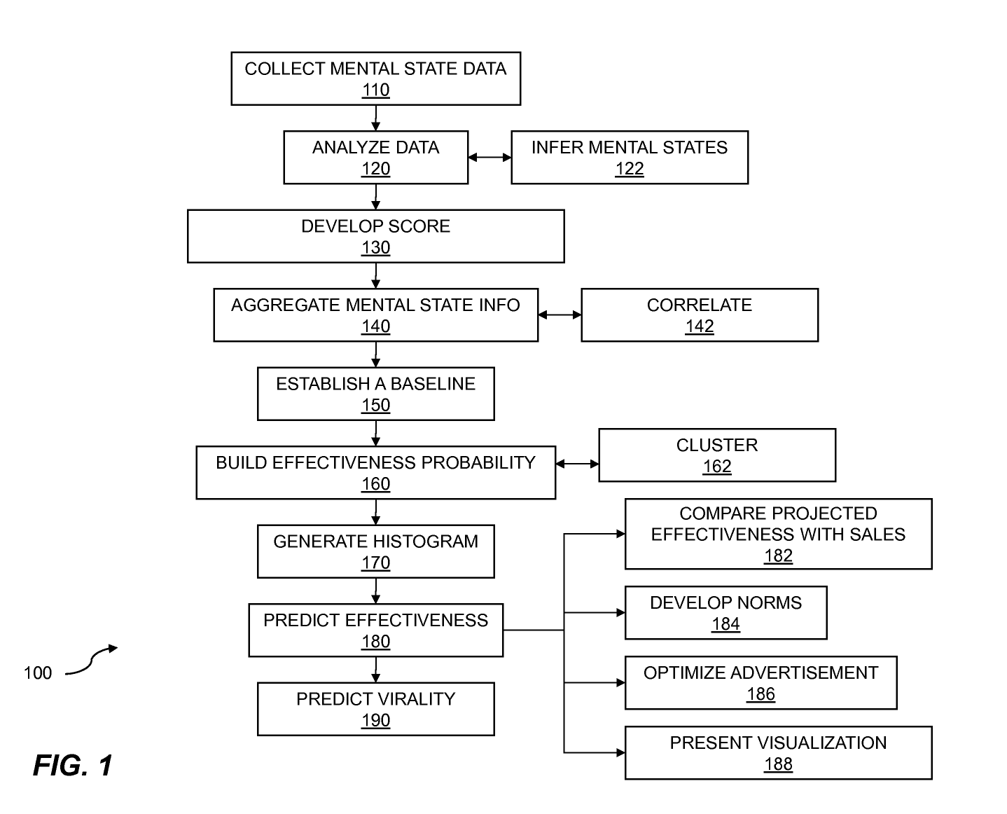

FIG. 1 is a flow diagram for evaluating advertisements. The flow 100 describes a computer-implemented method for advertisement evaluation. The evaluation may be based on analysis of viewers' mental states. The flow 100 may begin with collecting mental state data 110 from a plurality of people as they observe an advertisement. In embodiments, the mental state data includes facial data. An advertisement may be viewed on an electronic display. The electronic display may be any electronic display, including but not limited to, a computer display, a laptop screen, a net-book screen, a tablet computer screen, a cell phone display, a mobile device display, a television, a projection apparatus, or the like. The advertisement may include a product advertisement, a service advertisement, an entertainment advertisement, an educational message, a social awareness advertisement, a drive to action advertisement, a political advertisement, and the like. In some embodiments, the advertisement may be part of a live event. The collecting of mental state data may be part of the evaluation process for an advertisement. The mental state data 110 collected from the viewer may also include physiological data and actigraphy data. Physiological data may be obtained from video observations of a person. For example heart rate, heart rate variability, autonomic activity, respiration, and perspiration may be observed via video capture. Alternatively, in some embodiments, a biosensor may be used to capture physiological information and accelerometer readings. Permission may be requested and obtained prior to the collection of mental state data. The mental state data may be collected by a client computer system. A viewer or plurality of viewers may observe an advertisement or advertisements synchronously or asynchronously. In some embodiments, a viewer may be asked a series of questions about advertisements, and mental state data may be collected as the viewer responds to the questions.

The flow 100 may continue with analyzing the mental state data 120 to produce mental state information. While mental state data may be raw data such as heart rate, mental state information may include the raw data or information derived from the raw data. The mental state information may include the mental state data or a subset thereof. The mental state information may include valence and arousal. The mental state information may include information on the mental states experienced by the viewer or viewers. Eye tracking may be observed with a camera and may be used to identify portions of advertisements viewers may find amusing, annoying, entertaining, distracting, or the like. In embodiments, such analysis is based on the processing of mental state data from a plurality of people who observe the advertisement. Some analysis may be performed on a client computer before that data is uploaded. Analysis of the mental state data may take many forms, and may be based on one viewer or a plurality of viewers. The analysis may include information on attention. An attention score may be determined based on the position of a viewer's head, as well as, in some embodiments, where a viewer's eyes are directed. In this embodiment, a viewer turning away from the advertisement would cause the attention score to drop. A low attention score corresponds to a low level of effectiveness for the advertisement. Similarly, if the viewer becomes distracted for another reason, the effectiveness level of the advertisement drops. An awareness index may be developed to identify a viewer's awareness of the advertised product or service.

The flow 100 may continue with inferring mental states 122 about the advertisement based on the mental state data which was collected from a single viewer or a plurality of viewers. The mental state data may include information on mental states including one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity. The inferred mental states may be used to determine advertisement effectiveness. For example, one might infer that a higher level of viewers' confusion corresponds to a lower level of advertisement effectiveness. These mental states may be detected in response to viewing an advertisement or a specific portion thereof.

The flow 100 may continue with combining a plurality of effectiveness descriptors to develop a score 130 related to mental state analysis. The score may be a composite score and may include an expressiveness score. The In embodiments, a higher expressiveness score corresponds to a higher level of advertisement effectiveness. In some embodiments, the expressiveness score is related to total movement for faces of the plurality of people. The total movement may be based on identified facial action units (AU). Alternatively, total movement may be based on machine recognition of facial changes, movement of facial landmarks, and the like.

The flow 100 may continue with aggregating the mental state information 140 into an aggregated mental state analysis which is used in the predicting. The information aggregated is based on the mental state information from a plurality of viewers who observe the advertisement. The aggregated mental state information may include a probability for one or more effectiveness descriptors. In some embodiments, the effectiveness descriptors may be selected based on an advertisement objective. The probabilities of an effectiveness descriptor or a plurality of effectiveness descriptors may vary over time during the viewing of an advertisement. Various effectiveness descriptors may be considered and may include one or more of valence, action unit 4 (AU4), action unit 12 (AU12), and the like. The aggregated mental state information may allow the evaluation of a collective mental state of a plurality of viewers. In one representation, there may be “n” viewers of an advertisement and an effectiveness descriptor x^{k} may be used. An effectiveness descriptor may be aggregated over “n” viewers as follows:

$${X}^{k} = {\sum }_{i = 1}^{n} {x}_{i}^{k} ( t )$$

Mental state data may be aggregated 140 from a plurality of people, i.e. viewers, who have observed a particular advertisement. The aggregated information may be used to infer mental states of the group of viewers. The group of viewers may correspond to a particular demographic, such as men, women, people between the ages of 18 and 30, as well as other demographic groups. The aggregation may be based on sections of the population, demographic groups, and the like. Demographics may be collected for viewers and the collected demographic information may be used as part of the advertisement analysis. Differing groups within certain demographics may be aggregated separately for analysis. The flow 100 may further comprise correlating 142 the mental state data from the plurality of people. The flow 100 may include collecting mental state data from the plurality of people as they observe multiple advertisements and may further comprise clustering the multiple advertisements based on predicted effectiveness.

The flow 100 may continue with establishing a baseline 150 for the one or more effectiveness descriptors. The baseline may be established for an individual or for a plurality of individuals. In this manner, baseline data with regard to various effectiveness descriptors may be established for that viewer. Similarly, the baseline may also be established for a plurality of viewers. The baseline may be used in the aggregated mental state analysis and may include one of a minimum effectiveness descriptor value, a mean effectiveness value, an average effectiveness value, and the like. The baseline may be removed from an effectiveness descriptor as follows:

\tilde{X}=X(t)−baseline

The flow 100 may continue with building an effectiveness probability 160. A higher effectiveness probability correlates to a higher likelihood that the advertisement is effective. The effectiveness probability may be a combination of multiple effectiveness descriptors. Values for the effectiveness probability may be generated with respect to one or more of the viewers for the advertisement, sections of the advertisement, and the like. The effectiveness probability may provide an intensity level based on a combination of effectiveness descriptors. In embodiments, the effectiveness probability provides a number that indicates an advertisement's effectiveness by providing a higher or lower probability values.

The flow 100 may continue with generating a histogram 170 of the probabilities. The probabilities may relate to an effectiveness descriptor, multiple effectiveness descriptors, an effectiveness probability, and the like. For example, the histogram may represent a probability over time for a group of effectiveness descriptors. The histogram may include a summary probability for portions of the advertisement. For example, the portions may include quarters of the advertisement; at least a third quarter and a fourth quarter. Further, a third quarter probability for the advertisement may be higher than a fourth quarter probability for the advertisement. The third quarter's higher probability may correspond to higher advertisement effectiveness. A fourth quarter probability for the advertisement may be higher than a third quarter probability for the advertisement the fourth quarter having a higher probability may correspond to higher advertisement effectiveness. In another case, probabilities are identified at a segment in the advertisement when a brand is revealed. As the brand is revealed, in many cases, attention is normally high and valence is normally positive with corresponding probabilities. In embodiments, the histogram may show a probability of an effectiveness descriptor or a plurality of effectiveness descriptors, changes in probabilities over time, and the like. Probabilities may be evaluated based on distance along a hyperplane based on various classes. The distance may map to a probability score.

The flow 100 may continue with predicting an advertisement effectiveness 180 based on the mental state information. The predicting of the advertisement effectiveness may use one or more effectiveness descriptors and an effectiveness classifier. One or more of the effectiveness descriptors may have a larger standard deviation and the larger standard deviation may correspond to higher advertisement effectiveness.

The flow 100 may continue with comparing the projected advertisement effectiveness with actual sales 182. The sales behavior may include, but is not limited to, which product or products the viewer purchased or did not purchase. Embodiments of the present invention may determine correlations between mental states and sales behavior. Based on probabilities and other statistics extrapolated from mental state data collected from viewers of an advertisement, the advertisement can be projected to be either effective or ineffective. The advertisement effectiveness may be based on an advertisement objective such as entertainment, education, persuasion, startling, or a drive to action. If an analysis of mental state information gathered from a user or a plurality of users indicates one or more of the advertisement objectives has been met, then an advertisement may be considered more effective. In many cases, an advertisement which is correctly projected to be effective will result in greater product or service sales. The advertisement effectiveness may indicate a prediction of short term sales changes.

In embodiments, various facial metrics such as smile, valence, expressiveness, confusion, and so on, as well as a number of derivate metrics may be computed. For example, the mean value for each metric may be computed over the entire advertisement as well as the respondent level variability, the high and low percentiles of the curves, and the differences between first and second exposures. A variable or feature selection algorithm may be applied, such as using principal component analysis to the derivative variables. This analysis may give a top cohort of metrics that have the highest correlation with the sales data. A combined score of the top derivative metrics may be used to compute linear values and rank correlations with the sales index. Prediction efforts may include a leave-one-out method (also known as cross validation) where one ad out is removed from the analysis. Combined score prediction may then be used to evaluate the sales effectiveness of the advertisement that was removed. The process may be repeated for each advertisement is the database. The advertisement effectiveness may be based on multiple exposures to the advertisement.

The flow 100 may continue with developing norms 184 based on a plurality of advertisements. The developed norms can be used in predicting. A norm may be an expected value for an advertisement or of advertisements. By way of example, an entertaining advertisement could have an expected norm for a specific descriptor, such as AU12. For example, if developers produce an advertisement designed to be entertaining that does not generate a positive AU12 response, the advertisement can be deemed ineffective. Likewise, an advertisement designed for entertainment should provide a positive valence. The advertisement effectiveness may be based on an evaluation of a dynamics baseline. A dynamics baseline may include evaluation of a level of mental state expression that is foundational for a person or group of people. The dynamics baseline may be pertinent to a particular type of media presentation or advertisement.

The flow 100 may continue with optimizing the advertisement 186 based on the projected advertisement effectiveness. Additional advertisements may have been labeled effective or ineffective, based on data provided by human coders, actual sales, or the like. As mental state data is collected against these additional advertisements, the mental state data can be analyzed as described above and tested against an effectiveness classifier. An advertisement then may be optimized to, for example, maximize sales. The flow 100 may include presenting a subset of the mental state information in a visualization 188. The visualization may be presented on an electronic display. The visualization may further comprise a rendering based on the advertisement.

The flow 100 may continue with predicting virality 190 for the advertisement. Some advertisements may create an Internet sensation because they may be deemed by viewers to be particularly entertaining, humorous, educational, awareness enhancing, thought provoking, persuasive, startling, shocking, motivating, and the like. An advertisement may become an Internet sensation based on viewers wanting to share their viewing experiences with their friends and followers on the Internet. Such sharing may take place via a range of social media such as Twitter™, Facebook™, Google+™, Digg™, Tumblr™, YouTube™, and the like. Sharing by a viewer or viewers may take place via a wide range of popular social media platforms. Thus, a higher predicted virality value may indicate a higher likelihood that an advertisement would go viral and thus become an Internet sensation. Various steps in the flow 100 may be changed in order, repeated, omitted, or the like without departing from the disclosed inventive concepts.

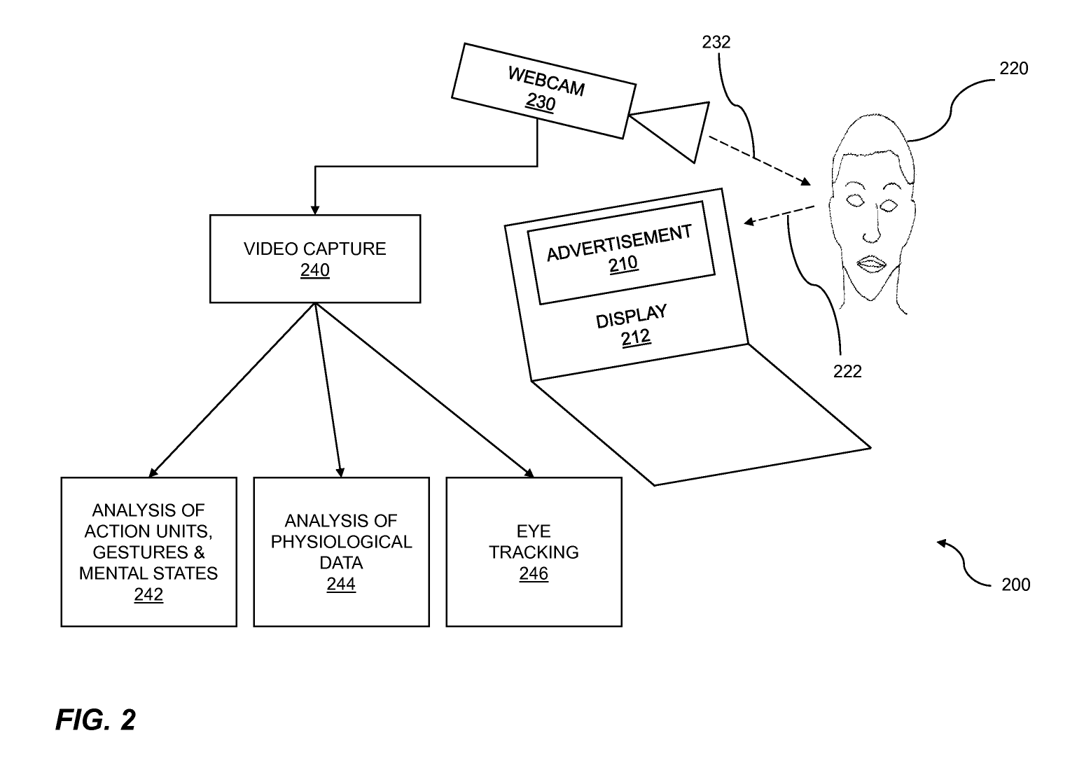

FIG. 2 is a system diagram for capturing mental state data in response to an advertisement 210. A viewer 220 has a line-of-sight 222 to a display 212. While one viewer has been shown, in practical use, embodiments of the present invention may analyze groups comprised of tens, hundreds, or thousands of people or more. Each viewer has a line of sight 222 to the advertisement 210 rendered on a display 212. An advertisement 210 may be a political advertisement, an educational advertisement, a product advertisement, a service advertisement, and so on.

The display 212 may be a television monitor, projector, computer monitor (including a laptop screen, a tablet screen, a net book screen, and the like), projection apparatus, a cell phone display, a mobile device, or other electronic display. A webcam 230 is configured and disposed such that it has a line-of-sight 232 to the viewer 220. In one embodiment, a webcam 230 is a networked digital camera that may take still and/or moving images of the face of the viewer 220 and possibly the body of the viewer 220 as well. A webcam 230 may be used to capture one or more of the facial data and the physiological data.

The webcam 230 may refer to any camera including a webcam, a camera on a computer (such as a laptop, a net book, a tablet, or the like), a video camera, a still camera, a cell phone camera, a mobile device camera (including, but not limited to, a forward facing camera), a thermal imager, a CCD device, a three-dimensional camera, a depth camera, multiple webcams used to show different views of the viewers or any other type of image capture apparatus that may allow image data captured to be used in an electronic system. The facial data from the webcam 230 is received by a video capture module 240 which may decompress the video into a raw format from a compressed format such as H.264, MPEG-2, or the like. The facial data may include information on action units, head gestures, smiles, brow furrows, squints, lowered eyebrows, raised eyebrows, attention, and the like.

The raw video data may then be processed for analysis of facial data, action units, gestures, and mental states 242. The facial data may further comprise head gestures. The facial data itself may include information on one or more of action units, head gestures, smiles, brow furrows, squints, lowered eyebrows, raised eyebrows, attention, and the like. The action units may be used to identify smiles, frowns, and other facial indicators of mental states. Gestures may include tilting the head to the side, leaning forward, a smile, a frown, as well as many other gestures. Physiological data may be analyzed 244 and eyes may be tracked 246. Physiological data may be obtained through the webcam 230 without contacting the individual. Respiration, heart rate, heart rate variability, perspiration, temperature, and other physiological indicators of mental state can be determined by analyzing the images. The physiological data may also be obtained by a variety of sensors, such as electrodermal sensors, temperature sensors, and heart rate sensors. The physiological data may include one of a group comprising electrodermal activity, heart rate, heart rate variability, respiration, and the like.

Eye tracking 246 of a viewer or plurality of viewers can be performed. The eye tracking may be used to identify a portion of the advertisement on which the viewer is focused. Further, in some embodiments, the process may include recording a viewer's eye dwell time on the rendering and associating information on the eye dwell time to the rendering and to the mental states. The eye dwell time can be used to augment the mental state information in order to indicate a viewer's level of interest in certain renderings or portions of renderings. The webcam observations may include a blink rate for the eyes. For example, a reduced blink rate may indicate significant engagement in what is being observed.

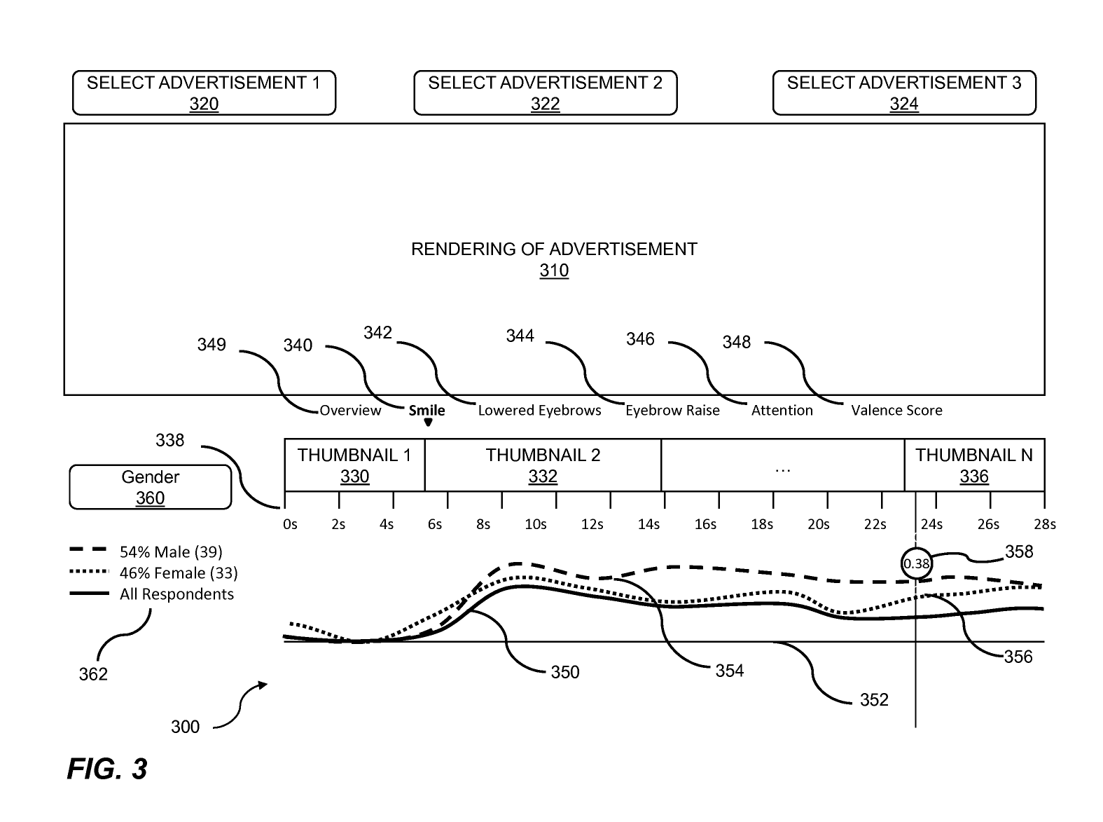

FIG. 3 is a graphical representation of mental state analysis. This graphical representation may be shown for advertisement analysis and may be presented on an electronic display. The display may be a television monitor, projector, computer monitor (including a laptop screen, a tablet screen, a net book screen, and the like), a cell phone display, a mobile device, or other electronic display. A rendering of an advertisement 310 may be presented in a window 300. An example window 300 is shown which includes the rendering of an advertisement 310 along with associated mental state information. A user may be able to select among a plurality of advertisements using various buttons and/or tabs such as Select Advertisement 1 button 320, Select Advertisement 2 button 322, Select Advertisement 3 button 324, and so on. Other numbers of selections are possible in various embodiments. In an alternative embodiment, a list box or drop-down menu is used to present a list of advertisements for display. The user interface allows a plurality of parameters to be displayed as a function of time, synchronized to the advertisement. Various embodiments may have any number of selections available for the user and some may be other types of renderings instead of video. A set of thumbnail images for the selected rendering, that in the example shown, include Thumbnail 1 330, Thumbnail 2 332, through Thumbnail N 336 may be shown below the rendering along with a timeline 338. The thumbnails may show a graphic “storyboard” of the advertisement. This storyboard may assist a user in identifying a particular scene or location within the advertisement. Some embodiments will not include thumbnails, or will have a single thumbnail associated with the rendering. Various other embodiments have thumbnails of equal length while still others have thumbnails of differing lengths. In some embodiments, the start and/or end of the thumbnails is determined based on changes in the captured viewer mental states associated with the rendering, or may be based on particular points of interest in the advertisement. Thumbnails of one or more viewers may be shown along the timeline 338. The thumbnails of viewers may include peak expressions, expressions at key points in the advertisement, etc.

Some embodiments may include the ability for a user to select a particular type of mental state information for display using various buttons or other selection methods. The mental state information may be based on one or more effectiveness descriptors. The one or more effectiveness descriptors may include one of AU12, AU4, and valence. For example, in the window 300, the smile mental state information has been previously selected for display by a user accessing the Smile 340 button. Other types of mental state information may also be available for user selection. In various embodiments, other mental state information includes the Lowered Eyebrows button 342, Eyebrow Raise button 344, Attention button 346, Valence Score button 348 or other types of mental state information, depending on the embodiment. An Overview button 349 may be available to allow a user to show graphs for each of the multiple types of mental state information simultaneously. The mental state information may include probability information for one or more effectiveness descriptors. The probabilities for the one of the one or more effectiveness descriptors may vary for portions of the advertisement.

Because the Smile option 340 has been selected in the example shown, a smile graph 350 may be shown against a baseline 352 displaying the aggregated smile mental state information of the plurality of individuals from whom mental state data was collected for the advertisement 310. The male smile graph 354 and the female smile graph 356 may be shown so that the visual representation displays the aggregated mental state information. The mental state information may be based on various demographic groups as they react to the advertisement. The various demographic based graphs may be indicated using various line types as shown or may be indicated using color or other method of differentiation. A slider 358 may allow a user to select a particular time of the timeline and show the value of the chosen mental state for that particular time. The mental states can be used to analyze the effectiveness of the advertisement. The slider 358 may either show the same or a different line type or color as the demographic group whose value is shown.

Various types of demographic-based mental state information can be selected using the demographic button 360, in some embodiments. Such demographics may include gender, age, race, income level, education, or any other type of demographic division, including dividing the respondents into those respondents that had higher reactions from those with lower reactions. A graph legend 362 may be displayed indicating the various demographic groups, the line type or color for each group, the percentage of total respondents and/or absolute number of respondents for each group, and/or other information about the demographic groups. The mental state information may be aggregated according to the demographic type selected. Thus, aggregation of the mental state information is performed on a demographic basis so that mental state information is grouped based on the demographic basis for some embodiments.

An advertiser may be interested in observing the mental state of a particular demographic group; people of a certain age range or gender, for example. In some embodiments, collected mental state data may be compared with self-report data obtained from the group of viewers. In this way, the analyzed mental states can be compared with the self-report information to see how well the two data sets correlate. In some instances, people may self-report a mental state other than their true mental state. For example, in some cases people may self-report a certain mental state either because they feel it is the “correct” response, or they are embarrassed to report their true mental state. The self-report comparison can serve to identify advertisements where the analyzed mental state deviates from the self-reported mental state.

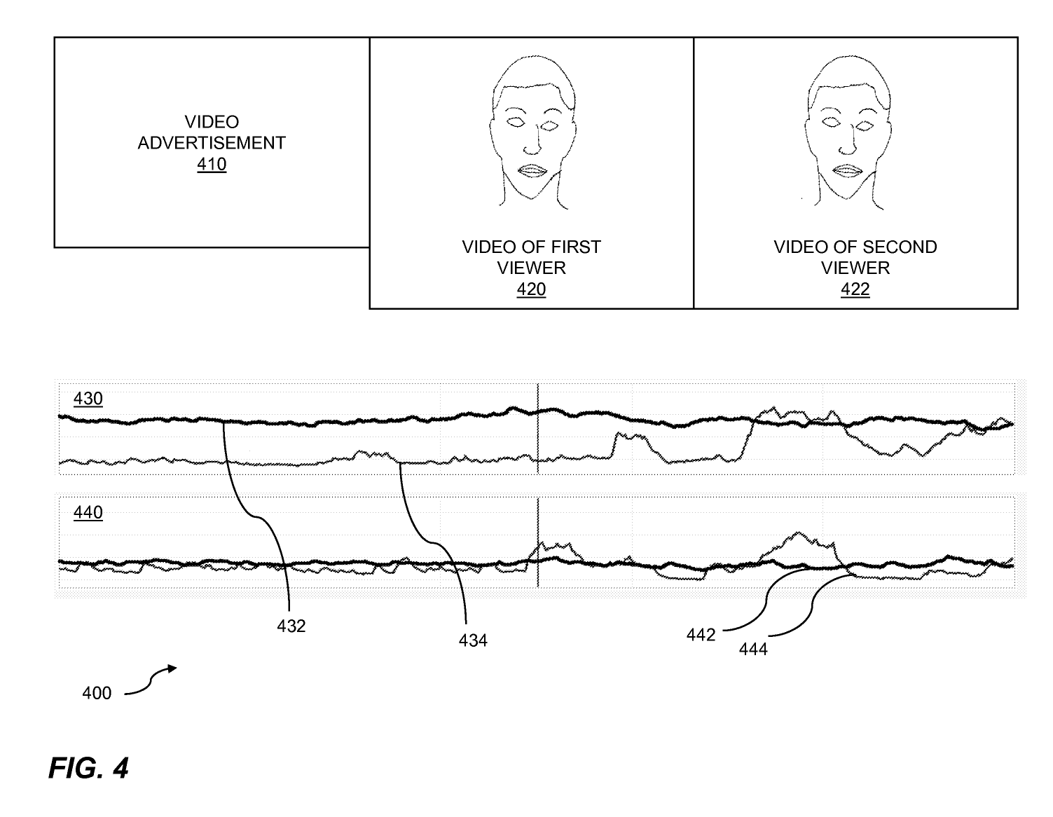

FIG. 4 is an example dashboard diagram for mental state analysis. The dashboard 400 may be a visualization presented on an electronic display. The visualization may present all or a subset of the mental state information as well as the advertisement or a rendering based on the advertisement. This dashboard-type representation may be used to render a mental state analysis on a display. A display may be a television monitor, projector, computer monitor (including a laptop screen, a tablet screen, a net book screen, and the like), projection apparatus, a cell phone display, a mobile device, or other electronic display. The dashboard 400 may include a video advertisement 410. The video advertisement 410 may be a video, still image, sequence of still images, a set of thumbnail images, and the like. The dashboard 400 may also include video of a viewer or a plurality of viewers. For example, the dashboard 400 may include video of a first viewer 420, video of a second viewer 422, and so on. The video for a viewer may be a video, a still image, a sequence of still images, a set of thumbnails, and so on.

The dashboard display 400 may allow for the comparison of graphs representing various mental state parameters for a given user. The dashboard display 400 may allow for the comparison of graphs representing various mental state parameters for a plurality of viewers. Various action unit graphs may be selected for display. For example, a certain graph 430 may be graphical representation of two parameters, AU4 432 and AU12 434, for a first viewer 420. Similarly, another graph 440 may be a graphical representation of two parameters, AU4 442 and AU12 444, for a second viewer 422. The graphs 430 and 440 may relate to probabilities, and the probabilities for one of the one or more effectiveness descriptors may vary between different portions of the advertisement. Multiple other advertisement videos, video clips, stills and the like may be shown.

For example, an advertising team may wish to test the effectiveness of an advertisement. An advertisement may be shown to a plurality of viewers in a focus group setting. The advertising team may notice an inflection point, such as a smile line, in one or more of the curves. The advertising team can then identify which point in the advertisement, in this example a product advertisement, invoked smiles from the viewers. Thus, content can be identified by the advertising team as being effective—or at least drawing a positive response. In this manner, viewer response can be obtained and analyzed.

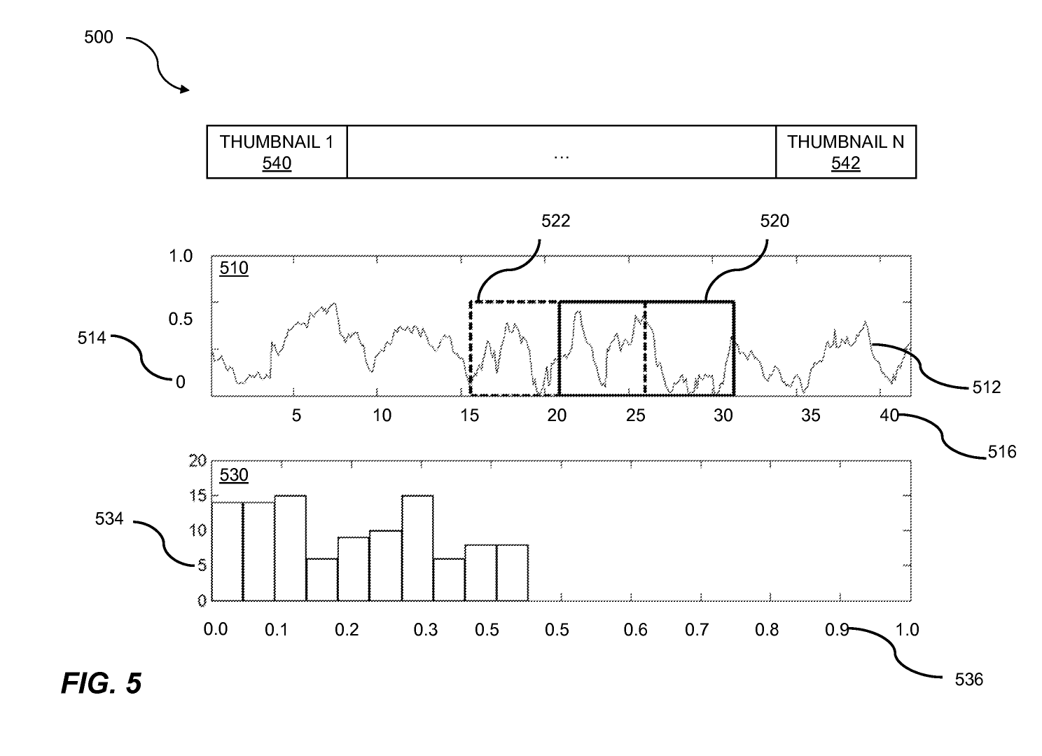

FIG. 5 is a diagram showing a graph and histogram for an advertisement. A window 500 may be shown which includes, in this example, a series of thumbnails of an advertisement: thumbnail 1 540 through thumbnail N 542. In an alternative embodiment, a list box or drop-down menu is used to present a list of images. The associated mental state information 512 for an advertisement may be displayed. Selections are possible in various embodiments, including selecting mental state data associated with the time of certain thumbnails. In an alternative embodiment, a list box or drop-down menu is used to present a list of times for display. The user interface allows a plurality of parameters to be displayed as a function of time, frame number, and the like, synchronized to the advertisement. A first window 510 is a display of affect showing an example display of probability for an effectiveness descriptor. The x-axis 516 may indicate relative time within an advertisement, frame number, or the like. In this example, the x-axis 516 may be for a 45 second advertisement. The probability, intensity, or other parameter of an affect may be given along the y-axis 514. In some embodiments, a higher value or point on the mental state information graph 512 may indicate a stronger probability of a smile. A sliding window 520 may be used to highlight or examine a portion of the graph 510. In this example, window 522 has been moved to the right to form window 520. These windows may be used to examine different times within the mental states collected for an advertisement, different periods within the advertisement, different quarters of the advertisement, and the like. In some embodiments, the window 520 may be expanded or shrunk as desired. Mental state information may be aggregated and presented; the mental state information may be based on the average, median, or other statistical or calculated value. The mental state information may be based on the information collected from an individual or a group of people. An advertisement effectiveness evaluation may be based on an advertisement objective. This advertisement objective may include one or more of a group comprising entertainment, education, awareness, persuasion, startling, and drive to action. Other advertisement objectives are also possible.

A window 500 may include a histogram 530 of the probabilities. The histogram may display the frequencies of probabilities from the first window 510. The histogram 530 may be for an entire advertisement. Alternatively, the histogram 530 may be constructed based on the position of a timing window 520. In this case, the histogram 530 describes frequencies of the probabilities from the mental state information graph 512. The histogram 530 may be generated for portions of the mental state information for the advertisement. The portions may include quarters of the advertisement in embodiments where there are four time periods in the advertisement. In some embodiments, mental state information may be gathered and used to compare and contrast first, second, and subsequent exposures to an advertisement. The X-axis 536 for the histogram 530 may indicate probabilities. In this example, the Y-axis 534 may represent frequencies of those probabilities. The portions may include quarters of the advertisement and the quarters may include at least a third quarter and a fourth quarter. In some embodiments, a third quarter probability for the advertisement is higher than a fourth quarter probability for the advertisement. A third quarter having a higher probability may correspond to higher advertisement effectiveness. In some embodiments, probabilities may increase with multiple views of the advertisement. When an advertisement is viewed repeatedly, certain probabilities, such as AU12 probabilities, may increase. Such an increase may indicate that an advertisement is effective. In embodiments, probabilities which increase may move to earlier points in time for the advertisement. For example, an entertaining advertisement may elicit smiles; upon second and third viewings of the advertisement, these smiles may occur earlier as the viewer smiles in anticipation of a previously encountered entertaining moment within the advertisement.

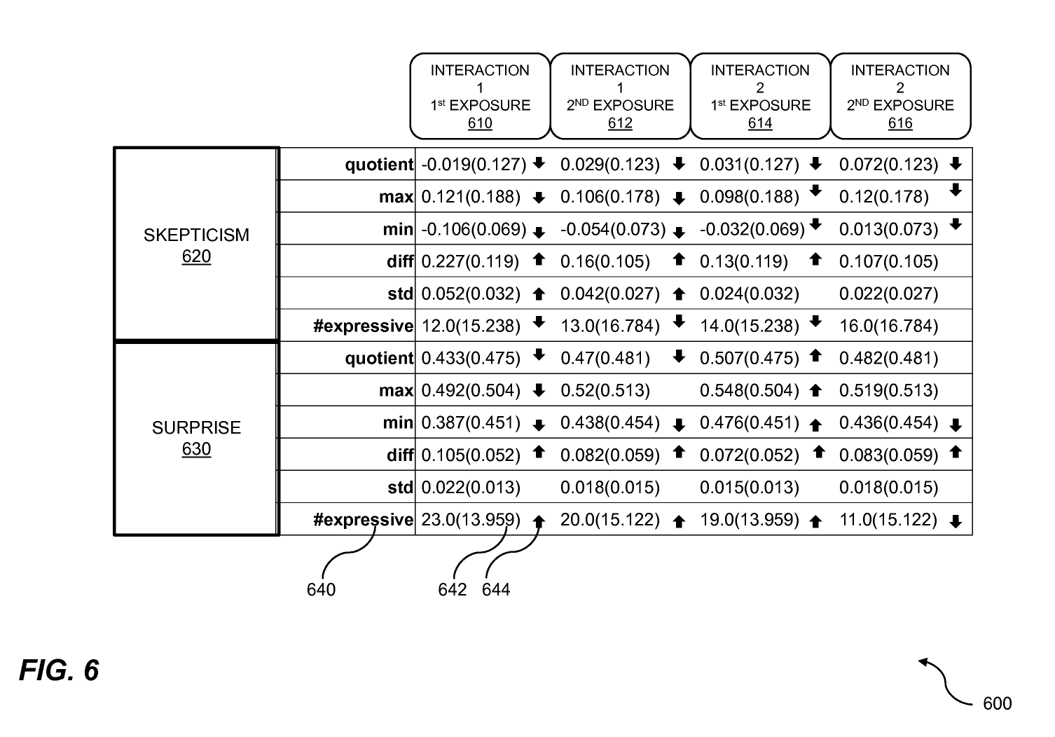

FIG. 6 is an example rendering including norms. A tabular representation 600 is shown with a table for Skepticism 620 and Surprise 630. The tabular results from two different advertisements and two separate exposures are shown for each of those advertisements. An advertisement 1, first exposure image 610 is shown as well as an advertisement 1, second exposure image 612. An advertisement 2, first exposure image 614 is shown as well as an advertisement 2, second exposure image 616. The various images could be an image selected from a video of their respective advertisements. Based on a first versus a second exposure analysis, a determination could be made on value of showing an advertisement multiple times. Values in a table could include a quotient for the mental state, a maximum value, a minimum value, a difference between the minimum and maximum value, a standard deviation, and a number of viewers who were expressive 640 of such a mental state upon seeing the interaction. Norms could be shown in parenthesis 642 for values expected for such an advertisement. Arrows 644 could be shown indicating when a value deviated significantly from such a norm. Norms may include evaluation of means, standard deviations, quartiles, derivatives of mental state data changes, and others. Numerous other types of tabular representation could be provided as well. Further, derivative metrics may provide meaning behind derivatives and capture more information on facial expressions. Mean values may be used to evaluate a difference between advertisements. Level variability may provide information on how polarized an advertisement was perceived. High and low percentiles for mental state data may be used to evaluate events within an advertisement. This type information can be used to determine when something did happen and provides a sense of moments of the advertisement when emotion is high or low. Additionally, wear out effect can be evaluated based on repeated exposures to advertisements. That information and others can be used to aid in evaluation of advertisement effectiveness.

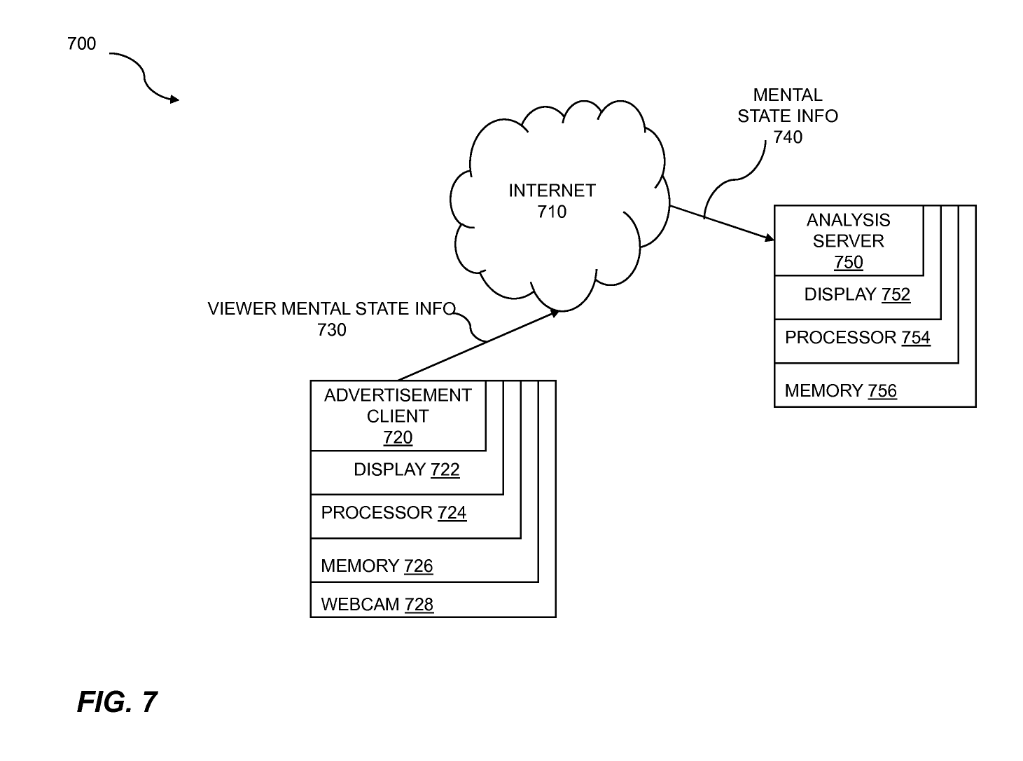

FIG. 7 is a system diagram for evaluating mental states. The Internet 710, intranet, or other computer network may be used for communication between various computers. An advertisement machine or client computer 720 has a memory 726 which stores instructions, and one or more processors 724 coupled to the memory 726 wherein the one or more processors 724 can execute instructions stored in the memory 726. The memory 726 may be used for storing instructions, for storing mental state data, for system support, and the like. The client computer 720 also may have an Internet connection to carry viewer mental state information 730, and a display 722 that may present various advertisements to one or more viewers. A display 722 may be any electronic display, including but not limited to, a computer display, a laptop screen, a net-book screen, a tablet screen, a cell phone display, a mobile device display, a remote with a display, a television, a projector, or the like. The client computer 720 may be able to collect mental state data from one or more viewers as they observe the advertisement or advertisements. In some embodiments, there are multiple client computers 720 that each may collect mental state data from viewers as they observe an advertisement. The advertisement client computer 720 may have a camera 728, such as a webcam, for capturing viewer interaction with an advertisement, including video of the viewer. The camera 728 may refer to a webcam, a camera on a computer (such as a laptop, a net book, a tablet, or the like), a video camera, a still camera, a cell phone camera, a mobile device camera (including, but not limited to, a forward facing camera), a thermal imager, a CCD device, a three-dimensional camera, a depth camera, and multiple webcams used to capture different views of viewers or any other type of image capture apparatus that may allow image data captured to be used by the electronic system.

Once the mental state data has been collected, the client computer may upload information to a server or analysis computer 750, based on the mental state data from the plurality of viewers who observe the advertisement. The client computer 720 may communicate with the analysis server 750 over the Internet 710, intranet, some other computer network, or by any other method suitable for communication between two computers. In some embodiments, the analysis server 750 functionality may be embodied in the client computer.

The analysis server 750 may have a connection to the Internet 710 so that mental state information 740 may be received by the analysis server 750. Further, the analysis server 750 may have a memory 757 which stores instructions, data, help information and the like, and one or more processors 754 attached to the memory 756 wherein the one or more processors 754 can execute instructions. The memory 756 may be used for storing instructions, for storing mental state data, for system support, and the like. The analysis computer may use the Internet or another computer communication method to obtain mental state information 740. The analysis computer 750 may receive mental state information collected from a plurality of viewers from the client computer or computers 720, and may aggregate mental state information on the plurality of viewers who observe the advertisement.

The analysis computer 750 may process mental state data or aggregated mental state data gathered from a viewer or a plurality of viewers to produce mental state information about the viewer or plurality of viewers. In some embodiments, the analysis server 750 may obtain mental state information 730 from the advertisement client 720. In this case, the mental state data captured by the advertisement client 720 was analyzed by the advertisement client 720 to produce mental state information for uploading.

Based on the produced mental state information, the analysis server may project an advertisement effectiveness. The analysis computer 750 may also associate the aggregated mental state information with both the rendering and the collection of norms for the context being measured.

In some embodiments, the analysis computer 750 may receive aggregated mental state information based on the mental state data from the plurality of viewers who observe the advertisement and may present aggregated mental state information in a rendering on a display 752. In some embodiments, the analysis computer may be set up for receiving mental state data collected from a plurality of viewers as they observe the advertisement, in a real-time or near real-time embodiment. In at least one embodiment, a single computer may incorporate the client, server and analysis functionality. Viewer mental state data may be collected from the client computer or computers 720 to form mental state information on the viewer or plurality of viewers watching an advertisement. The mental state information resulting from the analysis of the mental state date of a viewer or a plurality of viewers may be used to project an advertisement effectiveness based on the mental state information. The system 700 may include a computer program product embodied in a non-transitory computer readable medium for advertisement evaluation including code for collecting mental state data from a plurality of people as they observe an advertisement wherein the mental state data included facial data, code for analyzing the mental state data to produce mental state information, and code for projecting an advertisement effectiveness based on the mental state information.

Each of the above methods may be executed on one or more processors on one or more computer systems. Embodiments may include various forms of distributed computing, client/server computing, and cloud based computing. Further, it will be understood that for each flowchart in this disclosure, the depicted steps or boxes are provided for purposes of illustration and explanation only. The steps may be modified, omitted, or re-ordered and other steps may be added without departing from the scope of this disclosure. Further, each step may contain one or more sub-steps. While the foregoing drawings and description set forth functional aspects of the disclosed systems, no particular arrangement of software and/or hardware for implementing these functional aspects should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. Each element of the block diagrams and flowchart illustrations, as well as each respective combination of elements in the block diagrams and flowchart illustrations, illustrates a function, step or group of steps of the methods, apparatus, systems, computer program products and/or computer-implemented methods. Any and all such functions may be implemented by computer program instructions, by special-purpose hardware-based computer systems, by combinations of special purpose hardware and computer instructions, by combinations of general purpose hardware and computer instructions, by a computer system, and so on. Any and all of which implementations may be generally referred to herein as a “circuit,” “module,” or “system.”

A programmable apparatus that executes any of the above mentioned computer program products or computer implemented methods may include one or more processors, microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are not limited to applications involving conventional computer programs or programmable apparatus that run them. It is contemplated, for example, that embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized. The computer readable medium may be a non-transitory computer readable medium for storage. A computer readable storage medium may be electronic, magnetic, optical, electromagnetic, infrared, semiconductor, or any suitable combination of the foregoing. Further computer readable storage medium examples may include an electrical connection having one or more wires, a portable computer diskette, a hard disk, a random access memory (RAM), a read-only memory (ROM), an erasable programmable read-only memory (EPROM), Flash, MRAM, FeRAM, phase change memory, an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the entity causing the step to be performed.

While the invention has been disclosed in connection with preferred embodiments shown and described in detail, various modifications and improvements thereon will become apparent to those skilled in the art. Accordingly, the spirit and scope of the present invention is not to be limited by the foregoing examples, but is to be understood in the broadest sense allowable by law.

What is claimed is:

1. A computer implemented method for advertisement evaluation comprising:
collecting mental state data from a plurality of people as they observe an advertisement wherein the mental state data includes facial data;
analyzing the mental state data to produce mental state information; and
predicting an advertisement effectiveness based on the mental state information.

2. The method of claim 1 further comprising comparing the advertisement effectiveness that was predicted with actual sales.

3. The method of claim 1 wherein the advertisement effectiveness indicates a prediction of short term sales changes.

4. The method of claim 1 wherein the advertisement effectiveness is based on multiple exposures to the advertisement.

5. The method of claim 1 wherein the advertisement effectiveness is based on an advertisement objective which includes one or more of entertainment, education, awareness, persuasion, startling, or a drive to action.

6. The method of claim 1 wherein the predicting of the advertisement effectiveness uses one or more effectiveness descriptors and an effectiveness classifier.

7. The method of claim 6 wherein the predicting of the advertisement effectiveness is based on evaluation of a dynamics baseline.

8. The method of claim 6 wherein one of the one or more effectiveness descriptors has a larger standard deviation and the larger standard deviation corresponds to higher advertisement effectiveness.

9. The method of claim 8 further comprising developing norms based on a plurality of advertisements and wherein the norms are used in the predicting.

10. The method of claim 6 further comprising combining a plurality of effectiveness descriptors to develop an expressiveness score wherein a higher expressiveness score corresponds to a higher advertisement effectiveness.

11. The method of claim 10 wherein the expressiveness score is related to total movement for faces of the plurality of people.

12. The method of claim 6 wherein probabilities for one of the one or more effectiveness descriptors vary for portions of the advertisement.

13. The method of claim 12 wherein the probabilities are identified at a segment in the advertisement when a brand is revealed.

14. The method of claim 12 further comprising generating a histogram of the probabilities.

15. The method of claim 12 wherein the portions include quarters of the advertisement and the quarters include at least a third quarter and a fourth quarter.

16. The method of claim 15 wherein a third quarter probability for the advertisement is higher than a fourth quarter probability for the advertisement and wherein the third quarter having a higher probability corresponds to higher advertisement effectiveness.

17. The method of claim 15 wherein a fourth quarter probability for the advertisement is higher than a third quarter probability for the advertisement and wherein the fourth quarter having a higher probability corresponds to higher advertisement effectiveness.

18. The method of claim 17 wherein the one of the one or more effectiveness descriptors includes AU12 or valence.

19. The method of claim 12 wherein the probabilities increase with multiple views of the advertisement.

20. The method of claim 19 wherein the probabilities which increase move to earlier points in time for the advertisement.

21. The method of claim 6 further comprising establishing a baseline for the one or more effectiveness descriptors.

22. The method of claim 6 further comprising building an effectiveness probability wherein a higher effectiveness probability correlates to a higher likelihood that the advertisement is effective.

23. The method of claim 1 further comprising correlating the mental state data from the plurality of people.

24. The method of claim 1 further comprising collecting mental state data from the plurality of people as they observe multiple advertisements.

25. The method of claim 24 further comprising clustering the multiple advertisements based on predicted effectiveness.

26. The method of claim 1 further comprising predicting virality for the advertisement.

27. The method of claim 1 further comprising aggregating the mental state information into an aggregated mental state analysis which is used in the predicting.

28. The method of claim 1 further comprising optimizing the advertisement based on the advertisement effectiveness which was predicting.

29. The method of claim 1 wherein the mental state data also includes one or more of physiological data and actigraphy data.

30. The method of claim 29 wherein a webcam is used to capture one or more of the facial data and the physiological data.

31. The method of claim 1 further comprising inferring mental states about the advertisement based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity.

32. The method of claim 31 wherein confusion corresponds to a lower level of advertisement effectiveness.

33. The method of claim 1 further comprising presenting a subset of the mental state information in a visualization.

34. The method of claim 33 wherein the visualization is presented on an electronic display.

35. The method of claim 34 wherein the visualization further comprises a rendering based on the advertisement.

36. A computer program product embodied in a non-transitory computer readable medium for advertisement evaluation, the computer program product comprising:
code for collecting mental state data from a plurality of people as they observe an advertisement wherein the mental state data includes facial data;
code for analyzing the mental state data to produce mental state information; and
code for predicting an advertisement effectiveness based on the mental state information.

37. A computer system for advertisement evaluation comprising:
a memory which stores instructions;
one or more processors coupled to the memory wherein the one or more processors, when executing the instructions which are stored, are configured to:
collect mental state data from a plurality of people as they observe an advertisement wherein the mental state data includes facial data;
analyze the mental state data to produce mental state information; and
predict an advertisement effectiveness based on the mental state information.
